(19) United States
(12) Patent Application Publication
(10) Pub. No.: US 2021/0368605 A1
(43) Pub. Date: Nov. 25, 2021

(54) PANEL LIGHT WITH ISOLATED LOW VOLTAGE AUXILIARY POWER SUPPLY AUDIO INTERFACE

(71) Applicant: LONGHORN INTELLIGENT TECH CO., LTD, Shenzhen (CN)

(72) Inventors: Haitao YANG, Shenzhen (CN); Lei Li, Shenzhen (CN); Lin Yang, Shenzhen (CN); Feng Zhou, Shenzhen (CN)

(73) Assignee: LONGHORN INTELLIGENT TECH CO., LTD

(21) Appl. No.: 16/877,685

(22) Filed: May 19, 2020

(51) Int. Cl. H05B 47/12; H05B 45/40; G06F 3/16; G10L 15/00

(52) U.S. Cl. CPC H05B 47/12; G10L 15/00; G06F 3/167; H05B 45/40

(57) ABSTRACT

A panel light has an isolated low voltage direct current auxiliary power supply audio interface. The LED panel light has a DC power supply supplying the LED panel light. The DC power supply dim control is formed on the DC power supply supplying the LED panel light. The DC power supply dim control is configured as an input that adjusts the voltage or current of the LED panel light. A DC isolator circuit is connected to the DC power supply dim control. A low-voltage and dim power supply is connected to the DC isolator circuit. The low-voltage and dim power supply has an audio interface connection. The audio interface connects to the audio interface connection. The audio interface connection has an audio interface positive 12 V line, an audio interface ground line, and an audio interface dim line. A sensor connects to the audio interface at a sensor output.

This non-provisional utility application is by applicant Longhorn Intelligent Technology Co. Ltd. by inventors Haitao YANG, Lei LI, Lin YANG, and Feng ZHOU.

### FIELD OF THE INVENTION

The present invention is in the field of panel lighting, namely a panel light with isolated low voltage direct current auxiliary power supply audio interface.

### DISCUSSION OF RELATED ART

Panel lighting provides general room lighting from a wall or ceiling mounted panel. A variety of different panel lighting fixtures have been discussed in the prior art.

### SUMMARY OF THE INVENTION

The present invention has an output with isolated 12V/15V auxiliary power supply that shares the same transformer to increase the independent winding power supply and isolation from other circuits. The key feature of the present invention is that the 12V/15V auxiliary power supply adopts an audio interface with an LED driving power supply. The audio interface to installs to allow hot plugging addition of a sensor to add audio function to the LED light panel. Without the modular sensor, the LED light panel functions as a basic panel light.

A panel light has an isolated low voltage direct current auxiliary power supply audio interface. The LED panel light has a DC power supply supplying the LED panel light. The DC power supply dim control is formed on the DC power supply supplying the LED panel light. The DC power supply dim control is configured as an input that adjusts the voltage or current of the LED panel light. A DC isolator circuit is connected to the DC power supply dim control. A low-voltage and dim power supply is connected to the DC isolator circuit. The low-voltage and dim power supply has an audio interface connection. The audio interface connects to the audio interface connection. The audio interface connection has an audio interface positive 12 V line, an audio interface ground line, and an audio interface dim line. A sensor connects to the audio interface at a sensor output.

Optionally, the panel light with an isolated low voltage direct current auxiliary power supply audio interface has a low-voltage and dim power supply configured as a 12 V low-voltage and dim power supply. The audio interface connection can be an audio interface socket and plug connection and the socket can be formed on the low-voltage and dim power supply. The DC power supply receives an AC input from an AC/DC power supply load line and an AC/DC power supply neutral line. The DC power supply is an AC/DC power supply which receives AC power and converts it into DC power. The sensor can be a microphone or can include a microphone. The sensor may include and use a microphone for facilitating voice recognition capability for the audio interface.

### BRIEF DESCRIPTION OF THE DRAWINGS

FIG. 1 (prior art) shows a standard AC/DC constant current power supply plus 12V auxiliary power supply (version a).

FIG. 2 (prior art) shows a standard AC/DC constant current power supply plus 12V auxiliary power supply (version b).

FIG. 3 (prior art) shows a standard AC/DC constant voltage plus 12V auxiliary power supply.

FIG. 4 (prior art) shows a standard AC/DC constant current plus independent AC/DC auxiliary power supply.

FIG. 5 shows a present invention constant voltage power supply 12V auxiliary power supply isolation with audio interface.

FIG. 6 shows a present invention constant current power supply 12V auxiliary power supply isolation with audio interface of the present invention.

FIG. 7 shows a present invention independent 12V auxiliary power supply isolation with audio interface (a).

FIG. 8 shows a present invention independent 12V auxiliary power supply isolation with audio interface (b).

FIG. 9 shows a present invention assembly structure for the panel light and audio interface.

The following call out list of elements can be a useful guide for referencing the element numbers of the drawings.
20 AC/DC Power Supply
21 AC/DC power supply load line
22 AC/DC power supply neutral line
23 isolation circuit
25 AC/DC constant voltage isolated power supply
30 LED lamp
31 LED positive line
32 LED negative line
33 LED panel lens
34 LED panel housing
35 LED panel frame
40 DIM circuit
41 first DIM signal
42 second dim signal
50 12 V transformer
51 power supply for 12 V transformer
52 12 V non-isolated line
53 ground for dim
54 ground for sensor
55 12 V power for sensor
60 sensor
61 sensor output to dim
62 sensor output
63 audio interface connection aka audio interface socket and plug connection
70 DC to DC converter
80 audio interface
81 audio interface positive 12 V line
82 audio interface ground
83 audio interface dim line
84 low-voltage and dim power supply aka 12 V and dim power supply
85 dim positive power side line
86 dim negative power side line
87 DC isolator circuit
88 dim negative sensor side line
89 dim positive sensor side line
90 DC power supply dim control

### DETAILED DESCRIPTION OF THE PREFERRED EMBODIMENTS

### Glossary

LED stands for light-emitting diode, a type of lighting technology.
AC/DC stands for alternating current to direct current.
12 V stands for twelve volts.

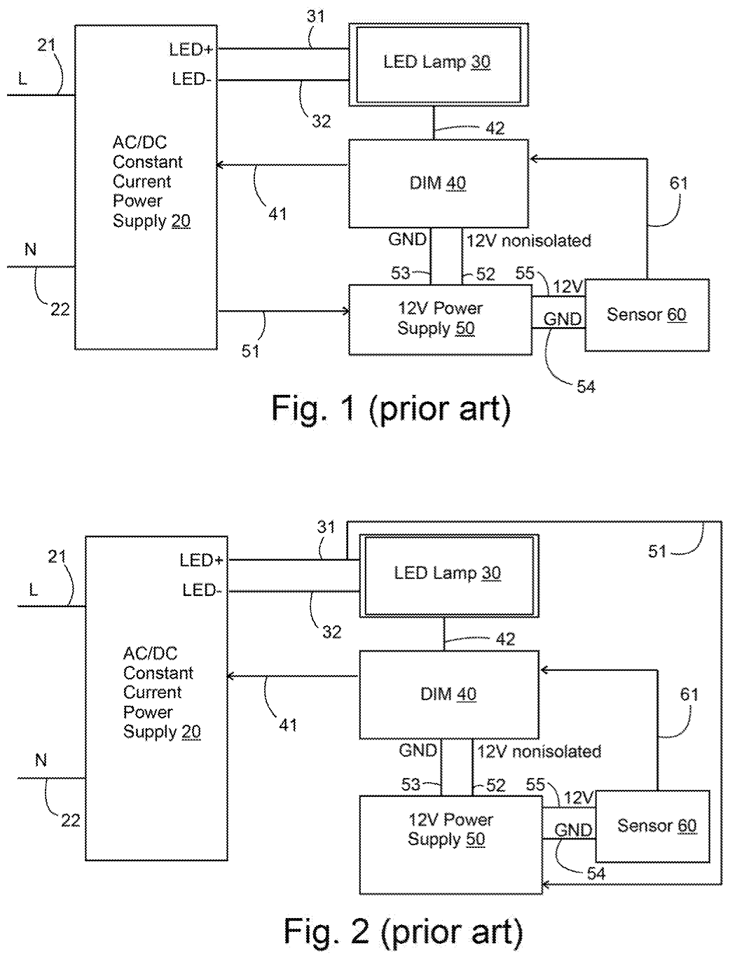

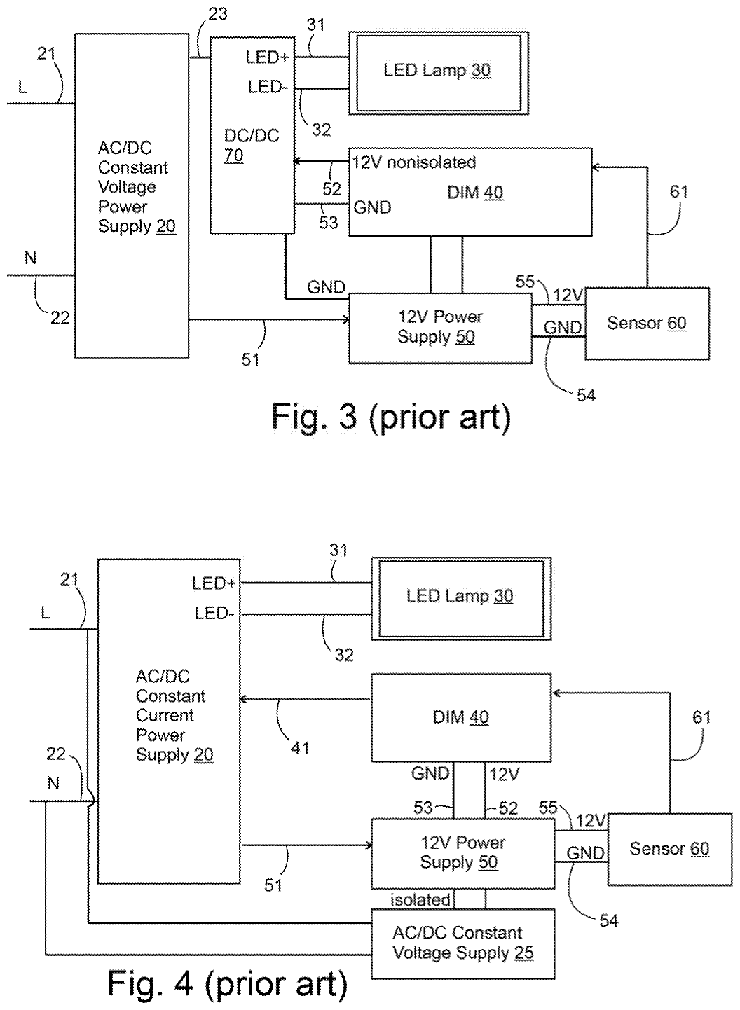

Current LED panel lights on the market have a driving power supply with a 12V auxiliary power supply as shown in FIGS. 1-4. Referring to FIG. 1, typically a load line 21 and a neutral line 22 are connected to an AC/DC power supply 20. The AC/DC power supply 20 can be a constant current power supply. The LED lamp 30 has an LED positive line 31 and an LED negative line 32 connected to the AC/DC power supply 20. The dim circuit 40 sends a first DIM signal 41 to the AC/DC power supply 20 for controlling the voltage of the LED lamp 30. A second DIM signal 42 can be used for feedback control and fine-tuning. A 12 V transformer 50 typically powers the dim circuit and may also power a sensor that sends a sensor output to dim signal 61 to the dim circuit 40. The sensor has a 12 V power for sensor 55, and a ground for sensor 54 connected to the 12 V transformer 50. The 12 V transformer 50 receives a power supply for 12 V transformer from the AC/DC power supply 20 and outputs a 12 V non-isolated line 52 and a ground for dim 53 to the dim circuit 40. Other similar configurations are shown in FIGS. 2-4.

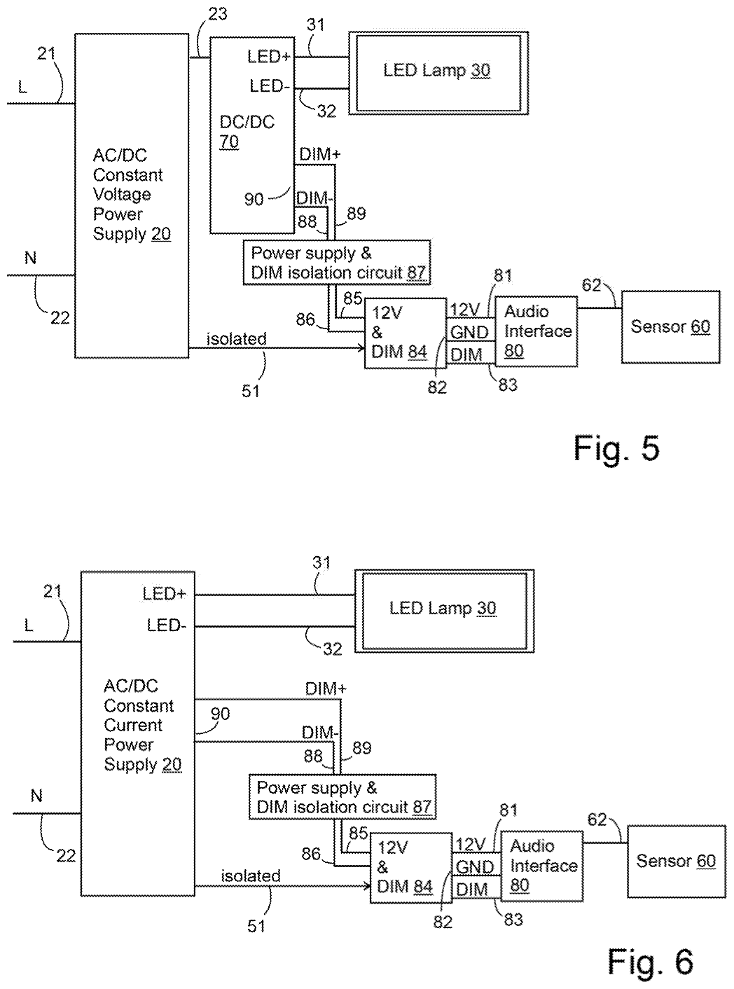

As shown in FIGS. 5-8, the typical configuration is modified in the present invention by adding a DC current isolator circuit 87 and a 12 V and dim power supply 84 with an audio interface 80 and a sensor connected to the audio interface 80. The audio interface 80 and the sensor 60 are modular and attach to the 12 V and dim power supply at an audio interface connection 63 which can be formed as an audio interface socket and plug connection 63. Note that the 12V is a nominal amount, and is not the actual voltage. The 12V current is preferred in automotive and lighting applications, however other applications may use a nominal voltage such as another low-voltage DC current. A low-voltage and dim power supply 84 can be implement as the 12 V and dim power supply 84.

The sensor 60 has a sensor signal output 62 to the audio interface 80. The sensor can be a microphone or light sensor or a combination of the two for example. The audio interface 80 has an audio interface positive 12 V line 81, an audio interface ground 82, and an audio interface dim line 83 connected to the 12 V and dim power supply 84. In turn, the 12 V and dim power supply 84 is connected to the DC current isolator circuit 87. The DC current isolator circuit 87 is connected to a DC power supply DIM control 90 at a dim positive sensor side line 89 and a dim negative sensor side line 88. The DC current isolator circuit 87 is connected to the low-voltage and dim power supply 84 also known as the 12 V and dim power supply 84 at the dim positive power side line 85 and the dim negative power side line 86.

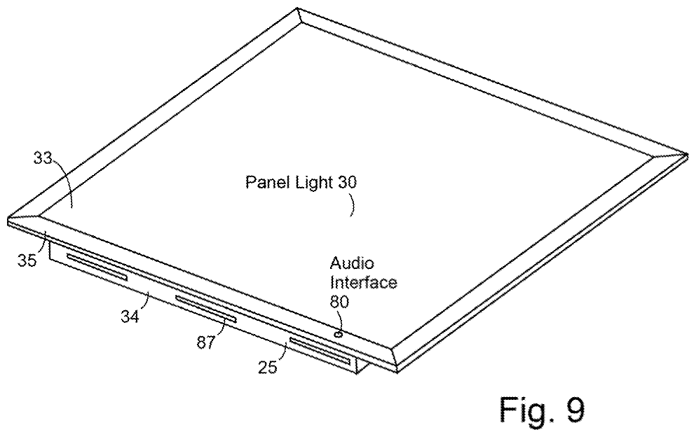

An external sensor for a panel light has can be installed in several ways. First, the back portion of the housing of the panel light can be formed with openings. This installation method is very inconvenient so it is not preferred. Also, the wiring has a risk of incorrect connection. Additionally, the installation of the sensor on the back of the panel light risks being influenced by interference from the backside. A second method of installation is to install the sensor on the ceiling near the panel light. This installation method has no direct relationship with the panel light, but the panel light is electrically connected with the sensor to achieve sensor function. Both of these physical topologies are not preferred. The preferred physical installation of the present invention differs in that it acoustically connects an audio sensor with the panel so that the panel receives acoustic signals for the sound sensor. As seen in FIG. 9, audio sensor is mounted in an opening on the frame of the panel light lens.

The current LED panel lights on the market have an electrical configuration where either the prior art auxiliary power supply is not isolated from the LED output terminal, or a separate AC/DC power supply is used to provide auxiliary power supply. Sometimes a the output power is then converted to a 12/15V auxiliary power supply, which is either not isolated, or the circuit is complicated and costly, which is very inconvenient when installing the sound sensor. The present invention differs from the standard LED panel lights by providing an isolated 12/15V auxiliary power supply and modular connection to an external sensor or controller.

As seen in FIGS. 5-9, the power output has a 12V/15V auxiliary power supply with 12V/15V isolation, and the power supply interface includes an audio interface.

Isolation can be by a transformer with inductive coil winding. A transformer increases auxiliary winding or independent AC/DC auxiliary power supply to provide an isolated auxiliary power supply such as isolated 12V/15V. The power supply interface adds a unique audio interface method. At the same time, the dimming is also isolated to improve safety. The safely isolated auxiliary power supply provides a plug in expansion for external sensors and controllers. By installing the audio interface on the aluminum frame, the customer can install the sensor without disassembly making it deploy and remove. The audio interface does not affect the panel light as one can quickly and easily switch between different functional requirements.

Users of this patented power supply, controller, and light fixture can flexibly choose to add an audio sensor or controller with audio interface to provide a smart voice assistant according to their needs. The standardization through the audio interface makes expansion installation very convenient. As the power supply is isolated and on low voltage, there will be no danger of electric shock. This makes installation easy, safe and reliable without need for tools.

A benefit of the present invention is that there is no need to add a separate auxiliary power supply for the audio interface and sensor because the audio interface and sensor can share the same power supply as the LED lamp. The addition of an auxiliary winding provides a safe isolation supply voltage. The power supply interface has an isolated novel audio interface method and dimming. The audio interface allows conversion to add an external voice sensor, which is convenient for end-user customers to choose. The voice sensor 60 can be a simple microphone, or a smart home assistant. The modular addition does not change the appearance of the panel light or the type of panel light.

A wide variety of different voice sensors and audio interfaces can be provided. For example, a digital voice assistant can be modularly attached to the light to allow verbal commands for dimming. A variety of different commercially available sensors can be mounted on the modular isolated power supply means. The sensors may have wireless protocols for communicating with Internet services, or have voice command capability. Digital voice assistants can control the lights and if provided with a speaker can relay information to the occupants. These digital voice assistants can come in a variety of different functionalities ranging from simple on-off light dimming control to assistants that have speaker functionality and can send messages and emails.

Alternatively, a simpler sound sensor that senses only occupancy can also be provided. The occupancy sound sensor listens for activity and turns off the lights when no activity is detected for a set amount of time. The occupancy sound sensor can be configured to turn on the lights when activity is detected. The occupancy sound sensor can also be configured to dim the lights according to user speech recognition commands. Thus, a wide variety of different sensors can be connected to the audio interface 80.

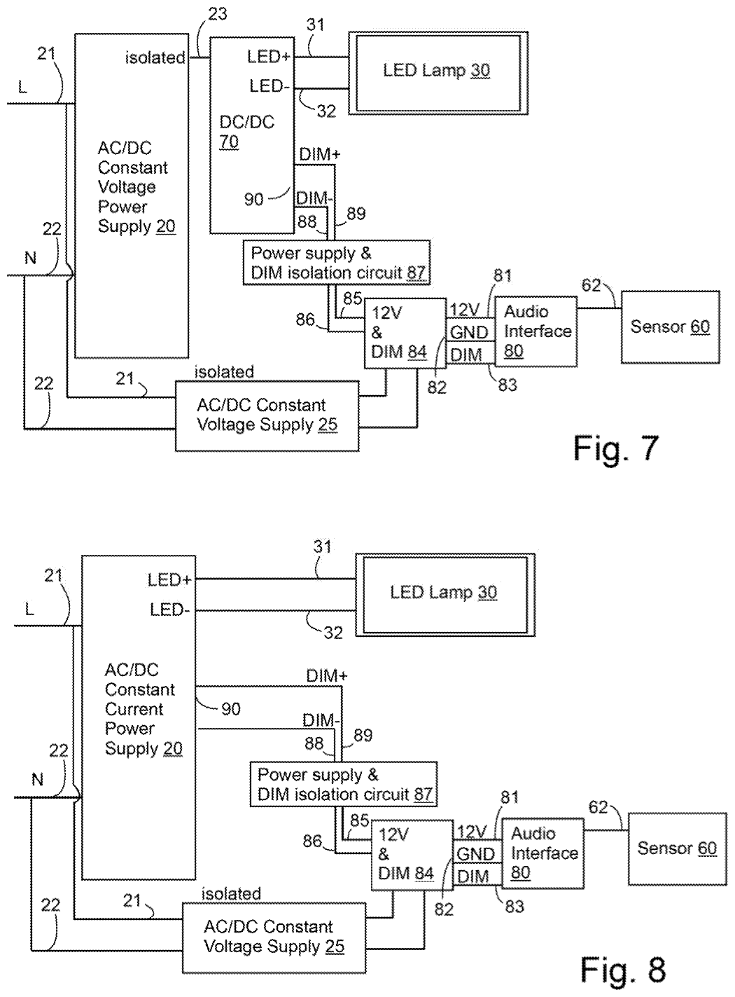

As seen in FIG. 7, optionally an AC/DC constant voltage isolated power supply 25 powers the 12 V and dim power supply 84. The AC/DC constant voltage isolated power supply 25 can be mounted on the LED panel housing 34 behind the LED panel lens 33 and the LED panel frame 35. The audio interface connection can be a plug and socket formed as a standard audio jack such as a phone connector, also known as a phone jack, audio jack, headphone jack or Jack plug. The phone connector is a family of electrical connectors typically used for analog audio signals. The phone connector was invented for use in telephone switchboards in the 19th century and is still widely used.

1. A panel light with an isolated low voltage direct current auxiliary power supply audio interface comprising:
an LED panel light;
a DC power supply supplying the LED panel light;
a DC power supply dim control formed on the DC power supply supplying the LED panel light, wherein the DC power supply dim control is configured as an input that adjusts the voltage or current of the LED panel light;
a DC isolator circuit, wherein the DC isolator circuit is connected to the DC power supply dim control;
a low-voltage and dim power supply connected to the DC isolator circuit, wherein the low-voltage and dim power supply has an audio interface connection;
an audio interface, wherein the audio interface connects to the audio interface connection, wherein the audio interface connection has an audio interface positive 12 V line, an audio interface ground line, and an audio interface dim line and;
a sensor, wherein the sensor connects to the audio interface at a sensor output.

2. The panel light with an isolated low voltage direct current auxiliary power supply audio interface of claim 1, wherein the low-voltage and dim power supply is a 12 V low-voltage and dim power supply.

3. The panel light with an isolated low voltage direct current auxiliary power supply audio interface of claim 1, wherein the audio interface connection is an audio interface socket and plug connection.

4. The panel light with an isolated low voltage direct current auxiliary power supply audio interface of claim 1, wherein the audio interface connection is an audio interface socket and plug connection where the socket is formed on the low-voltage and dim power supply.

5. The panel light with an isolated low voltage direct current auxiliary power supply audio interface of claim 1, wherein the DC power supply receives an AC input from an AC/DC power supply load line and an AC/DC power supply neutral line, wherein the DC power supply is an AC/DC power supply which receives AC power and converts it into DC power.

6. The panel light with an isolated low voltage direct current auxiliary power supply audio interface of claim 1, wherein the sensor is a microphone.

7. The panel light with an isolated low voltage direct current auxiliary power supply audio interface of claim 1, wherein the sensor includes a microphone, and wherein the audio interface has voice recognition capability.

8. The panel light with an isolated low voltage direct current auxiliary power supply audio interface of claim 1, wherein the sensor includes a microphone.

9. The panel light with an isolated low voltage direct current auxiliary power supply audio interface of claim 8, wherein the low-voltage and dim power supply is a 12 V low-voltage and dim power supply.

10. The panel light with an isolated low voltage direct current auxiliary power supply audio interface of claim 8, wherein the audio interface connection is an audio interface socket and plug connection.

11. The panel light with an isolated low voltage direct current auxiliary power supply audio interface of claim 8, wherein the audio interface connection is an audio interface socket and plug connection.

12. The panel light with an isolated low voltage direct current auxiliary power supply audio interface of claim 8, wherein the DC power supply receives an AC input from an AC/DC power supply load line and an AC/DC power supply neutral line, wherein the DC power supply is an AC/DC power supply which receives AC power and converts it into DC power.
